(19) United States
(12) Patent Application Publication
(10) Pub. No.: US 2017/0355238 A1
(43) Pub. Date: Dec. 14, 2017

(54) RUBBER ARTICLE INCLUDING ELECTRONICS DEVICE FASTENER

(71) Applicant: Bridgestone Americas Tire Operations, LLC, Nashville, TN (US)

(72) Inventors: Terence E. Wei, Copley, OH (US); Hans R. Dorfi, Akron, OH (US); Paul B. Wilson, Tallmadge, OH (US); Sheel P. Agarwal, Solon, OH (US); Andrew T. Miklic, Akron, OH (US); Adam K. Nesbitt, Akron, OH (US); Douglas B. Costlow, Akron, OH (US); Ross W. Widenor, Stow, OH (US); John D. Rensel, Tallmadge, OH (US)

(73) Assignee: Bridgestone Americas Tire Operations, LLC, Nashville, TN (US)

(21) Appl. No.: 15/540,901

(22) PCT Filed: Oct. 9, 2015
(86) PCT No.: PCT/US15/54806

§ 371 Date: Jun. 29, 2017

Related U.S. Application Data
(60) Provisional application No. 62/098,327, filed on Dec. 30, 2014.

(51) Int. Cl. B60C 23/04; B29D 30/00

(52) U.S. Cl. CPC B60C 23/0493; B29D 2030/0083; B29D 2030/0072; B29D 2030/0077

(57) ABSTRACT

A rubber article having an electronics device fastener is provided. In one embodiment, a tire is provided, the tire comprising: a first surface; a second surface; and a tire body contained between the first surface and the second surface; wherein the tire body comprises a cavity having a cavity major width in at least one of an axial direction and a circumferential direction, wherein a channel extends between the cavity and the first surface, wherein the channel has a channel major width in at least one of the axial direction and the circumferential direction, wherein the cavity major width is greater than the channel major width, and wherein a protrusion of a fastener is engaged within the cavity.

### CROSS-REFERENCE TO RELATED APPLICATIONS

### BACKGROUND

In the manufacture of a rubber article, including for example a vehicle tire, it may be desirable to attach devices to the rubber article through easily attachable and/or removable methods. For example, it may be desirable to attach electronic devices to rubber articles, including for example, sensors, power generators, transmitters, identification devices, and the like.

Traditionally, attachment of devices to a rubber article, including for example a vehicle tire, may involve adhesion of a device to the rubber article, or alternatively adhesion of a base element to the rubber article, wherein the device is rigidly attached to the base element. However, many rubber articles bend repeatedly during use. For example, a vehicle tire typically undergoes various deformations upon ever revolution of the tire. As a result, devices or base elements adhered to a rubber article may delaminate from the rubber article, thus permitting the device to be lost or damaged, or otherwise causing down time in the rubber article.

What is needed is a system for attaching devices, such as electronic devices, to rubber articles.

### SUMMARY

In one embodiment, a tire is provided, the tire comprising: a first surface; a second surface; and a tire body contained between the first surface and the second surface; wherein the tire body comprises a cavity having a cavity major width in at least one of an axial direction and a circumferential direction, wherein a channel extends between the cavity and the first surface, wherein the channel has a channel major width in at least one of the axial direction and the circumferential direction, wherein the cavity major width is greater than the channel major width, and wherein a protrusion of a fastener is engaged within the cavity.

In one embodiment, a rubber article is provided, the rubber article comprising: a surface; and a body; wherein the body comprises a cavity having a cavity major width, wherein a channel extends between the cavity and the surface, wherein the channel has a channel major width, wherein the cavity major width is greater than the channel major width, and wherein a protrusion of a fastener is engaged within the cavity.

In one embodiment, a tire having a device is provided, the tire comprising: a first surface; a second surface; a fastener having a protrusion, wherein the fastener is engaged with a device; and a tire body contained between the first surface and the second surface; wherein the tire body comprises a cavity having a cavity shape and a cavity major width in at least one of an axial direction and a circumferential direction, wherein a channel extends between the cavity and the first surface, wherein the channel has a channel major width in at least one of the axial direction and the circumferential direction, wherein the cavity major width is greater than the channel major width, wherein the protrusion has a protrusion shape that is complimentary to the cavity shape, and wherein the protrusion is engaged within the cavity.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1A illustrates a side sectional view of a rubber article having a cavity connected to a surface of the article via a channel.

FIG. 1B illustrates a bottom sectional view of a rubber article having a cavity connected to a surface of the article via a channel.

FIG. 2 illustrates a sectional view of a fastener having a protrusion for engaging a cavity of a rubber article.

FIG. 3 illustrates a sectional view of a fastener having a protrusion for engaging a cavity of a rubber article, coupled to a rubber article featuring a cavity.

FIG. 4A illustrates a sectional view of a fastener having a protrusion for engaging a cavity of a tire, fastened to a device and coupled to a tire featuring a cavity.

FIG. 4B illustrates a sectional view of a fastener having a protrusion for engaging a cavity of a tire, fastened to a device and coupled to a tire featuring a cavity.

FIG. 5A illustrates a sectional view of a fastener having a protrusion for engaging a cavity of a tire, fastened to a device and coupled to a tire featuring a cavity.

FIG. 5B illustrates a sectional view of a fastener having a protrusion for engaging a cavity of a tire, fastened to a device and coupled to a tire featuring a cavity.

FIG. 5C illustrates a sectional view of a fastener having a protrusion for engaging a cavity of a tire, fastened to a device and coupled to a tire featuring a cavity.

FIG. 6 illustrates a sectional view of a fastener having a protrusion for engaging a cavity of a rubber article, fastened to a device and coupled to a rubber article featuring a cavity.

FIG. 7 illustrates a sectional view of a fastener having a protrusion for engaging a cavity of a rubber article, fastened to a device and coupled to a rubber article featuring a cavity.

FIG. 8 illustrates a sectional view of a fastener having a protrusion for engaging a cavity of a rubber article, fastened to a device and coupled to a rubber article featuring a cavity.

FIG. 9 illustrates a sectional view of a fastener having a protrusion for engaging a cavity of a rubber article, fastened to a device and coupled to a rubber article featuring a cavity.

### DETAILED DESCRIPTION

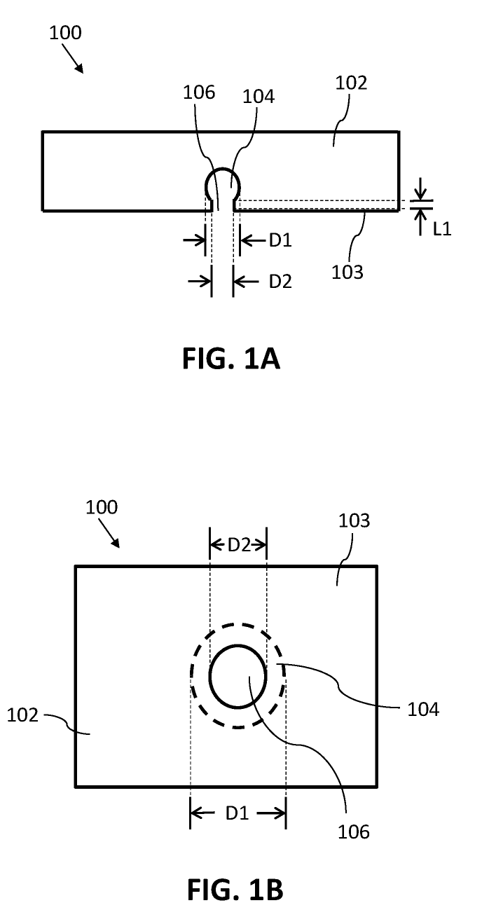

FIG. 1A illustrates a side sectional view of a rubber article 100. Rubber article 100 may include a body 102. Body 102 may include at least one surface 103. Body 102 may include a cavity 104. Cavity 104 may be oriented within a portion of body 102. Cavity 104 may be in communication with the at least one surface 103 via a channel 106.

Rubber article 100 may include any of a variety of articles. Rubber article 100 may be an article having elastic properties and capable of deforming and returning to a shape that is substantially the same as its original shape. Rubber article 100 may include a vehicle tire. Rubber article 100 may include a pneumatic vehicle tire. Rubber article 100 may include a non-pneumatic vehicle tire. Rubber article 100 may include an air spring. Rubber article 100 may include a rubber article for attachment to another rubber article, including for example a vehicle tire or an air spring. Such a rubber article for attachment to another rubber article may be referred to as a “patch.” The patch may be bonded to another rubber article through any of a variety of mechanisms, including for example through an adhesive, an epoxy, crosslinking, and the like. The patch may be laminated to another rubber article. Rubber article 100 may include any of a variety of rubber articles to which one may desire to attach a device, such as an electronic device.

Body 102 may include any portion of rubber article 100 having sufficient dimensions to include cavity 104. Body 102 may include a portion of a vehicle tire. Body 102 may include a portion of a vehicle tire in the crown region of the tire. Body 102 may include a portion of a vehicle tire in the shoulder region of the tire. Body 102 may include a portion of a vehicle tire in the sidewall region of the tire. Body 102 may include at least a portion of a patch for attachment to a rubber article, including for example a tire. Body 102 may be comprised of a rubber material. Body 102 may be comprised of a polymer material. Body 102 may be a composite of any of a variety of materials.

Surface 103 may be any surface of body 102. Surface 103 may be any surface of body 102 to which one wishes to attach a device. Surface 103 may be defined as a first surface of rubber article 100, wherein body 102 is contained between the first surface of rubber article 100 and a second surface of rubber article 100. Rubber article 100 may be generally oriented as a container with an interior and an exterior, wherein surface 103 is at least one of an interior surface and an exterior surface. Surface 103 may be a first surface and an interior surface, while a second surface may be an exterior surface. Alternatively, surface 103 may be a first surface and an exterior surface, while a second surface may be an interior surface. Surface 103 may be an innerliner material within a vehicle tire. Surface 103 may be an interior surface of a tire. Surface 103 may be an interior surface of a tire in a crown region of the tire. Surface 103 may be an interior surface of a tire in a shoulder region of the tire. Surface 103 may be an interior surface of a tire in a sidewall region of the tire. Surface 103 may be an interior surface of a tire in a bead region of the tire. Surface 103 may be an exterior surface of a tire. Surface 103 may be an exterior surface of a tire in a shoulder region of the tire. Surface 103 may be an exterior surface of a tire in a sidewall region of the tire. Surface 103 may be an exterior surface of a tire in a bead region of the tire. Surface 103 may be a surface of a patch to be attached to a rubber article, including for example a tire. Surface 103 may be a surface of a patch substantially opposite a surface of the patch to be attached to the rubber article. Surface 103 may be an interior surface of a tire in a crown region of the tire, where a second surface is a tread surface of a tire. Surface 103 may be an interior surface of a tire in a sidewall region of the tire, where a second surface is a sidewall surface of a tire. Surface 103 may be a tread surface of a tire, where a second surface is an interior surface of a tire in a crown region of the tire. Surface 103 may be a sidewall surface of attire, where a second surface is an interior surface of a tire in a sidewall region of the tire.

Cavity 104 may be oriented within body 102 a distance from surface 103. Cavity 104 may be oriented such that cavity 104 communicates with surface 103 via channel 106. Alternatively, cavity 104 may be shaped such that it may communicate with surface 103 without a channel 106.

Cavity 104 may be a generally sphere-shaped cavity. Cavity 104 may be a generally cylinder-shaped cavity. Cavity 104 may be a generally teardrop-shaped cavity. Cavity 104 may be a generally cone-shaped cavity. Cavity 104 may be a generally cube-shaped cavity. Cavity 104 may be a generally cuboid-shaped cavity. Cavity 104 may be a generally pyramid-shaped cavity. Cavity 104 may be a generally tetrahedron-shaped cavity. Cavity 104 may be a generally ribbed cavity, including at least one rib. Cavity 104 may have any of a variety of shapes. Cavity 104 may include any shape capable of accepting a corresponding shape attached to a device. Cavity 104 may include any three dimensional shape capable of creating an interference fit with a corresponding protrusion from a device.

Cavity 104 may have a cavity major width D1. Cavity major width D1 may be measured substantially parallel to surface 103. Where rubber article 100 is a vehicle tire, cavity major width D1 may be measured in at least one of an axial direction and a circumferential direction within the tire. Cavity major width D1 may be defined as the maximum width of cavity 104 measured substantially parallel to surface 103. Cavity major width D1 may be defined as the maximum width of cavity 104 measured in an axial direction within a tire. Cavity major width D1 may be defined as the maximum width of cavity 104 measured in a circumferential direction within a tire.

Channel 106 may be a void connecting cavity 104 to surface 103. Channel 106 may extend between cavity 104 and surface 103. Channel 106 may be configured to accept a protrusion from a device and allow the protrusion to be extended through channel 106 and engage cavity 104. Channel 106 may be substantially cylindrical in shape. Channel 106 may be substantially cuboid in shape. Channel 106 may have a substantially circular cross-section. Channel 106 may have any of a variety of cross-sections.

Channel 106 may include a channel length L1. Channel length L1 may be measured substantially perpendicular to surface 103. Where rubber article 100 is a vehicle tire, channel length L1 may be measured in at least one of a radial direction and an axial direction within the tire. Length L1 may be any of a variety of lengths. Length L1 may be about 2.0 mm. Length L1 may be between about 1.0 mm and about 3.0 mm. Length L1 may be between about 0.5 mm and about 5.0 mm. Length L1 may be between about 1.0 mm and about 7.0 mm.

Channel 106 may have a channel major width D2. Channel major width D2 may be measured substantially parallel to surface 103. Where rubber article 100 is a vehicle tire, channel major width D2 may be measured in at least one of an axial direction and a circumferential direction within the tire. Channel major width D2 may be defined as the maximum width of channel 106 measured substantially parallel to surface 103. Channel major width D2 may be defined as the maximum width of channel 106 measured in an axial direction within a tire. Channel major width D2 may be defined as the maximum width of channel 106 measured in a circumferential direction within a tire.

Cavity major width D1 may be greater than channel major width D2. Cavity major width D11 may be between about 110% and about 400% of channel major width D2. Cavity major width D11 may be between about 150% and about 300% of channel major width D2. Cavity major width D1 may be between about 200% and about 250% of channel major width D2. Cavity major width D1 may be about 250% of channel major width D2. Cavity major width D1 may be between about 200% and about 300% of channel major width D2. Cavity major width D1 may be about equal to channel major width D2.

In one embodiment, cavity major width D11 may be about 5.0 mm. Cavity major width D11 may be between about 1.0 mm and about 10.0 mm. Cavity major width D11 may be between about 3.0 mm and about 7.0 mm. Cavity major width D1 may be between about 4.0 mm and about 6.0 mm.

Channel major width D2 may be about 2.0 mm. Channel major width D2 may be between about 0.2 mm and about 8.0 mm. Channel major width D2 may be between about 0.5 mm and about 5.0 mm. Channel major width D2 may be between about 1.0 mm and about 3.0 mm.

Channel 106 may be oriented so as to deform at least partially and expand to allow a protrusion (not shown) corresponding to cavity 104 to pass through. Channel 106 may be bound at least partially by a deformable material, such as for example a rubber, a polymer, and the like. Channel 106 may be configured so as to maintain its shape and not deform during passage therethrough of a protrusion (not shown) corresponding to cavity 104, but rather the protrusion may deform to fit through channel 106 to engage cavity 104. Alternatively, rubber article 100 may have no channel 106, but rather, cavity 104 may be in communication with surface 103 without the need for channel 106.

Cavity 104 may be molded into rubber article 100 during the molding and/or creation of rubber article 100. Cavity 104 may be formed into rubber article 100 after the molding and/or creation of rubber article 100, for example by cutting away material from rubber article 100 to form cavity 104.

Channel 106 may be molded into rubber article 100 during the molding and/or creation of rubber article 100. Channel 106 may be formed into rubber article 100 after the molding and/or creation of rubber article 100, for example by cutting away material from rubber article 100 to form channel 106.

FIG. 1B illustrates a bottom sectional view of a rubber article 100. As illustrated, each of cavity 104 and channel 106 may have a substantially circular cross-section. Cavity major width D1 may be greater than channel major width D2.

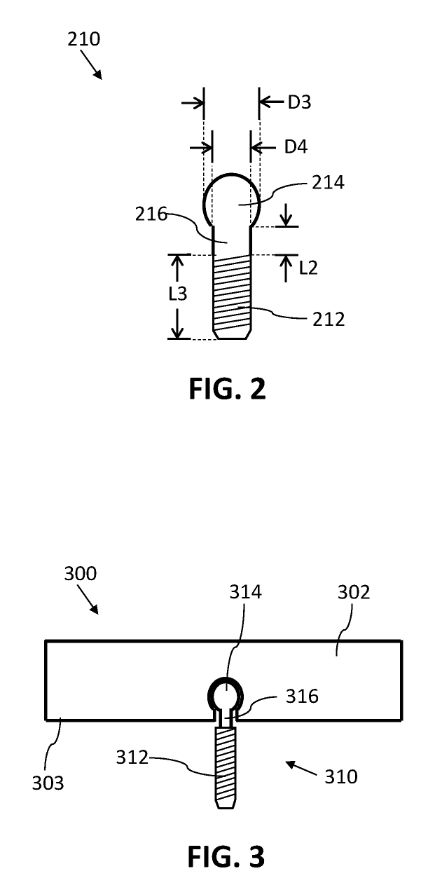

FIG. 2 illustrates a sectional view of an device fastener 210 having a protrusion 214 for engaging a cavity of a rubber article (not shown). Device fastener 210 may include a fastener portion 212. Protrusion 214 may be oriented adjacent fastener portion 212. Protrusion 214 may attach to fastener portion 212 via a stem 216.

Device fastener 210 may be configured to attach a device (not shown) to a rubber article. The device may be any of a variety of devices. The device may be any device that one would desire to attach to a rubber article. The device may include a tire electronics package. The device may be any device that one would desire to attach to a vehicle tire. The device may include any of a variety of devices, including sensors, power generators, transmitters, identification devices, and the like. The device may include a pressure sensor for measuring air pressure within a rubber article. The device may include a temperature sensor for measuring temperature within a rubber article. The device may include a radio frequency transmitter for transmitting information to a receiver. The device may include a power generator configured to generate electricity during use of a rubber article, such as a vehicle tire. The device may include a power storage unit such as a battery. Any of the various devices described herein may be attached to fastener portion 212 of device fastener 210. Fastener portion 212 may attach to any of the various devices described herein.

Fastener portion 212 may be integrally connected to at least one of stem 216 and protrusion 214. Fastener portion 212 may be removably connected to at least one of stem 216 and protrusion 214. Fastener portion 212 may be any of a variety of fasteners, including for example a threaded fastener, a rivet, a bolt, a screw, a nail, a pin, a quick disconnect, a magnet, a barbed fitting, a press-fit connector, a ligature, a strap, an adhesive, and the like. Fastener portion 212 may be configured to removably attach to a device. Fastener portion 212 may be configured to permanently attach to a device.

In one embodiment, fastener portion 212 may include a threaded fastener with a nut. In this embodiment, at least a portion of fastener portion 212 may extend through an aperture in a device. The nut may be threaded onto fastener portion 212 to at least partially secure the device to device fastener 210. In another embodiment, fastener portion 212 may be a threaded fastener having threads corresponding to threads in a device. In this embodiment, at least a portion of fastener portion 212 may extend into, and threadably engage with, a threaded aperture in a device.

Fastener portion 212 may comprise any of a variety of materials, including for example a rubber, a polymer, a metal, an alloy, a composite, an organic material, an inorganic material, and the like. Fastener portion 212 may be substantially rigid and configured to resist bending or other deformation of fastener portion 212. Fastener portion 212 may be substantially resilient and configured to allow bending or other deformation of fastener portion 212.

Protrusion 214 may substantially correspond in shape to a cavity, such as cavity 104 illustrated in FIG. 1. Protrusion 214 may substantially correspond in size to a cavity in a rubber article. Protrusion 214 may substantially correspond in shape and size to a cavity in a rubber article. Protrusion 214 may have any of the variety of possible shapes and cross-sections as discussed above with respect to cavity 104 in FIG. 1. Protrusion 214 may be a ribbed member having at least one rib oriented about the member and configured to maintain protrusion 214 inside cavity 104.

Protrusion 214 may comprise any of a variety of materials, including for example a rubber, a polymer, a metal, an alloy, a composite, an organic material, an inorganic material, and the like. Protrusion 214 may include a material capable of deforming such that protrusion 214 may pass through a channel, such as channel 106 illustrated in FIG. 1. Protrusion 214 may include a material that is rigid and configured to not deform as it passes through a channel, such as channel 106. Protrusion 214 may include a material that has a hardness greater than the hardness of material surrounding channel 106. Protrusion 214 may include a material that deforms less than channel 106. Protrusion 214 may include a material that deforms more than channel 106. Protrusion 214 may include a material that deforms the same as channel 106. Protrusion 214 may include a structure that deforms less than channel 106. Protrusion 214 may include a structure that deforms more than channel 106. Protrusion 214 may include a structure that deforms the same as channel 106.

Stem 216 may comprise any of a variety of materials, including for example a rubber, a polymer, a metal, an alloy, a composite, an organic material, an inorganic material, and the like. Stem 216 may have any of the variety of possible shapes and cross-sections as discussed above with respect to channel 106 in FIG. 1. For example, stem 216 may have a substantially circular cross-section.

Either or both of protrusion 214 and stem 216 may be integrally connected to fastener portion 212. Either or both of protrusion 214 and stem 216 may be removably connected to fastener portion 212. Either or both of protrusion 214 and stem 216 may be integrally connected to fastener portion 212 and formed, machined, or molded with fastener portion 212. Either or both of protrusion 214 and stem 216 may be integrally connected to fastener portion 212 and adhered, threaded, riveted, or otherwise fastened to fastener portion 212.

Protrusion 214 may have a protrusion major width D3. Stem 216 may have a stem major width D4. Protrusion major width D3 may be greater than stem major width D4.

Protrusion major width D3 may be about the same as cavity major width D1. Protrusion major width D3 may be greater than cavity major width D1. Protrusion major width D3 may be less than cavity major width D1. Protrusion major width D3 may be greater than channel major width D2.

Stem major width D4 may be about the same as channel major width D2. Stem major width D4 may be greater than channel major width D2. Stem major width D4 may be less than channel major width D2.

Protrusion major width D3 may be between about 110% and about 400% of stem major width D4. Protrusion major width D3 may be between about 150% and about 300% of stem major width D4. Protrusion major width D3 may be between about 200% and about 250% of stem major width D4. Protrusion major width D3 may be about equal to stem major width D4.

Protrusion major width D3 may be between about 110% and about 400% of channel major width D2. Protrusion major width D3 may be between about 150% and about 300% of channel major width D2. Protrusion major width D3 may be between about 200% and about 250% of channel major width D2. Protrusion major width D3 may be between about 200% and about 300% of channel major width D2. Protrusion major width D3 may be about 250% of channel major width D2. Protrusion major width D3 may be about equal to channel major width D2.

In one embodiment, protrusion major width D3 may be about 5.0 mm. Protrusion major width D3 may be between about 1.0 mm and about 10.0 mm. Protrusion major width D3 may be between about 3.0 mm and about 7.0 mm. Protrusion major width D3 may be between about 4.0 mm and about 6.0 mm.

Stem major width D4 may be about 2.0 mm. Stem major width D4 may be between about 0.2 mm and about 8.0 mm. Stem major width D4 may be between about 0.5 mm and about 5.0 mm. Stem major width D4 may be between about 1.0 mm and about 3.0 mm.

Stem 216 may include a stem length L2. Stem length L2 may be measured substantially longitudinal along device fastener 210. Where device fastener 210 is attached to a rubber article, and the rubber article is a vehicle tire, stem length L2 may be measured in at least one of a radial direction and an axial direction within the tire. Stem length L2 may be any of a variety of lengths. Stem length L2 may be about 2.0 mm. Stem length L2 may be between about 1.0 mm and about 3.0 mm. Stem length L2 may be between about 0.5 mm and about 5.0 mm. Stem length L2 may be between about 1.0 mm and about 7.0 mm.

Fastener portion 212 may include a fastener portion length L3. Fastener portion length L3 may be any length as necessitated for attaching a device to fastener 210. Fastener portion length L3 may be between about 1.0 mm and about 50.0 mm.

FIG. 3 illustrates a sectional view of a rubber article 300 having a body 302. Rubber article 300 may have a surface 303. Surface 303 may include a channel, similar to channel 106 described above with reference to FIG. 1, which channel communicates with a cavity similar to cavity 104.

A fastener 310 may be coupled to rubber article 300. Fastener 310 may include a fastener portion 312. Fastener 310 may include a protrusion 314 for engaging a cavity of rubber article 300. Protrusion 314 may be oriented adjacent fastener portion 312. Protrusion 314 may attach to fastener portion 312 via a stem 316.

As illustrated, protrusion 314 may be oriented in a cavity of rubber article 300. Stem 316 may be oriented in a channel of rubber article 300. In one embodiment, fastener 310 may be attached to rubber article 300 by inserting protrusion 314 into a cavity in rubber article 300, similar to cavity 104 described in FIG. 1. Protrusion 314 may be first inserted into a channel, similar to channel 106, and forced therethrough and into a cavity, similar to cavity 104. As a result, protrusion 314 may engage a cavity, similar to cavity 104, while stem 316 is oriented in a channel, similar to channel 106. Fastener 310, including fastener portion 312 may be coupled to rubber article 300 in such a manner.

Fastener 310 may be separated from rubber article 300 by forcing protrusion 314 from a cavity and through a channel, similar to cavity 104 and channel 106, respectively. In such a manner, fastener 310 may be decoupled from rubber article 300.

In one embodiment, a single protrusion 314 and cavity combination may be used to attach fastener 310 to rubber article 300. In another embodiment, a plurality of protrusions 314 may be coupled to a plurality of cavities, to create a plurality of protrusion 314 and cavity combinations to attach fastener 310 to rubber article 300. In another embodiment, a plurality of fasteners 310 may be coupled to a single rubber article 300 via a plurality of combinations of protrusions 314 and cavities.

As illustrated, and with reference to FIG. 2 above, protrusion major width D3 may be measured substantially parallel to surface 303. Where rubber article 300 is a vehicle tire, protrusion major width D3 may be measured in at least one of an axial direction and a circumferential direction within the tire. Protrusion major width D3 may be defined as the maximum width of protrusion 314 measured substantially parallel to surface 303. Protrusion major width D3 may be defined as the maximum width of protrusion 314 measured in an axial direction within a tire. Protrusion major width D3 may be defined as the maximum width of protrusion 314 measured in a circumferential direction within a tire.

As illustrated, and with reference to FIG. 2 above, stem major width D4 may be measured substantially parallel to surface 303. Where rubber article 300 is a vehicle tire, stem major width D4 may be measured in at least one of an axial direction and a circumferential direction within the tire. Stem major width D4 may be defined as the maximum width of stem 316 measured substantially parallel to surface 303. Stem major width D4 may be defined as the maximum width of stem 316 measured in an axial direction within a tire. Stem major width D4 may be defined as the maximum width of stem 316 measured in a circumferential direction within a tire.

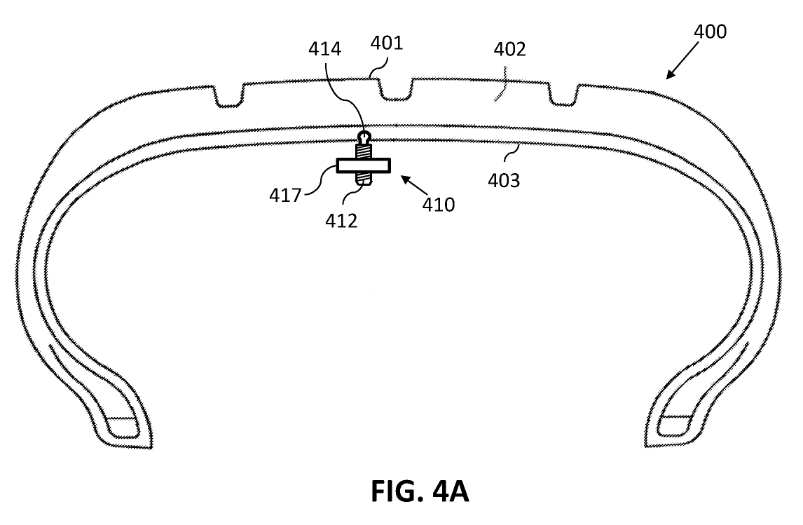

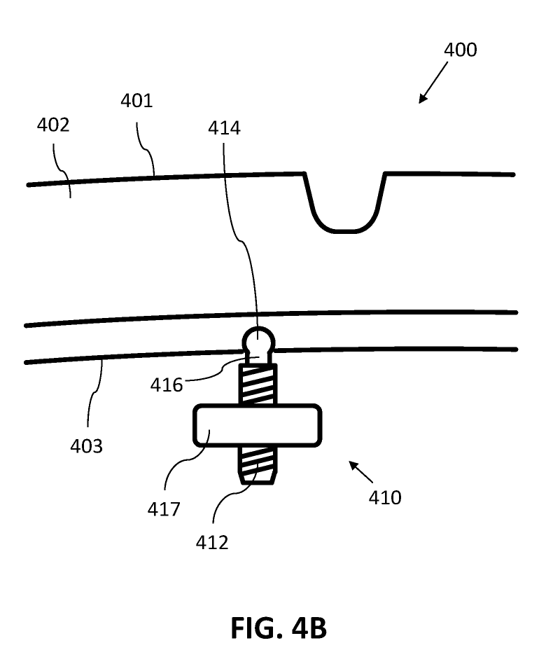

FIG. 4A illustrates a sectional view of a rubber article in the form of a tire 400 having a body 402. Tire 400 may include a tread surface 401. Tire 400 may have an inner surface 403. Inner surface 403 may include a channel, similar to channel 106 described above with reference to FIG. 1, which channel communicates with a cavity similar to cavity 104.

A fastener 410 may be coupled to tire 400. Fastener 410 may include a fastener portion 412. Fastener 410 may include a protrusion 414 for engaging a cavity of tire 400. Protrusion 414 may be oriented adjacent fastener portion 412. Protrusion 414 may attach to fastener portion 412 via a stem.

A device 417 may be operatively connected to fastener portion 412. In this manner, device 417 may be operatively connected to a rubber article, such as tire 400. Device 417 may be threadably connected to fastener portion 412. Device 417 may be removably connected to fastener portion 412. Device 417 may be integrally connected to fastener portion 412.

Body 402 may be contained between tread surface 401 of the tire and inner surface 403. Inner surface 403 may be an innerliner. Body 402 may be contained between tread surface 401 of the tire and the innerliner.

In this manner, fastener 410 may be attached to tire 400 following molding of tire 400. Fastener 410 may be attached to tire 400 prior to molding of tire 400. Fastener 410 may be attached to tire 400 prior to curing of tire 400. Fastener 410 may be attached to tire 400 following curing of tire 400. Fastener 410 may be attached to tire 400 by a tire installer at a retail facility. Fastener 410 may be attached to tire 400 via an interference fit between protrusion 414 and a cavity in tire 400, similar to cavity 104 referenced in FIG. 1. Similarly, fastener 410 may be detached from tire 400 at any point following its attachment. Fastener 410 may be removed from tire 400 and replaced with another fastener 410. In such a manner, fastener 410 may be replaced with a new undamaged fastener, a different style of fastener, an upgraded fastener, and the like. Fastener 410 may be added to tire 400 without causing damage to tire 400 or device 410. Device 410 may be removed from tire 400 without causing damage to tire 400.

Device 417 may be attached to fastener 410 at any point prior to, or during installation of tire 400 on a vehicle. Device 417 may be attached to fastener 410 before fastener 410 is attached to tire 400. Device 417 may be attached to fastener 410 after fastener 410 is attached to tire 400. Device 417 may be selectively attached to fastener 410, and as a result device 417 may be selectively removed from fastener 410 and replaced with a new undamaged device, a different style of device, an upgraded device, a device with fresh batteries, and the like. Device 417 may be selectively attached to and detached from fastener 410 depending upon a user's desired use of device 417. That is, device 417 may be added to tire 400 when necessary or desired, and device 417 may be removed from tire 400 when unnecessary or undesired.

Inner surface 403 may include a tire innerliner. In one embodiment, the tire innerliner may be pierced by the channel, similar to channel 106, to allow communication between the cavity, similar to cavity 104, and inner surface 403. In another embodiment, the tire innerliner may follow the walls and contours formed by the channel and the cavity so as to form a continuous layer within the entire interior of the tire.

Body 402 may include a tire carcass. In one embodiment, the tire carcass may include any of a variety of reinforcement materials, including for example cords. At least one of the channel and the cavity may extend through the reinforcement materials. The reinforcement materials may be pieced by at least one of the channel and the cavity. The reinforcement materials may extend around at least one of the channel and the cavity so as to form a continuous reinforcement along the carcass. In another embodiment, the tire carcass may include any of a variety of reinforcement materials, including for example cords. The reinforcement materials may be oriented radially outwardly of at least one of the channel and the cavity. The reinforcement materials may be oriented radially outwardly of both the channel and the cavity, such that the reinforcement materials form a continuous reinforcement along the carcass.

Fastener 410 may be attached to tire 400 via one or more combination of protrusion 414 and a cavity. That is, fastener 410 may include one or more protrusion configured to engage one or more cavity. It is contemplated that the addition of protrusions and cavities may increase the retention of fastener 410 within tire 400. It is contemplated that the addition of fasteners 410 within tire 400 may increase the retention of device 417 within tire 400.

FIG. 4B illustrates a partial sectional view of tire 400 and fastener 410. As illustrated, protrusion 414 may be attached to fastener 410 via a stem 416.

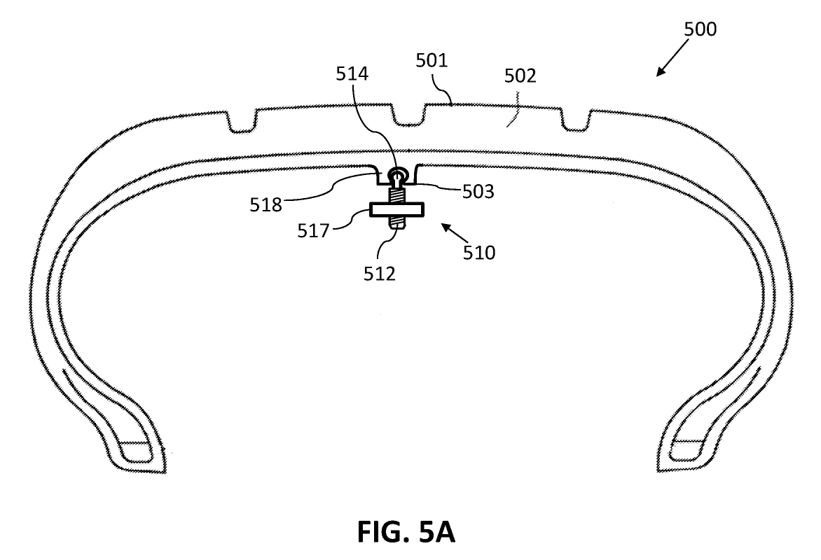

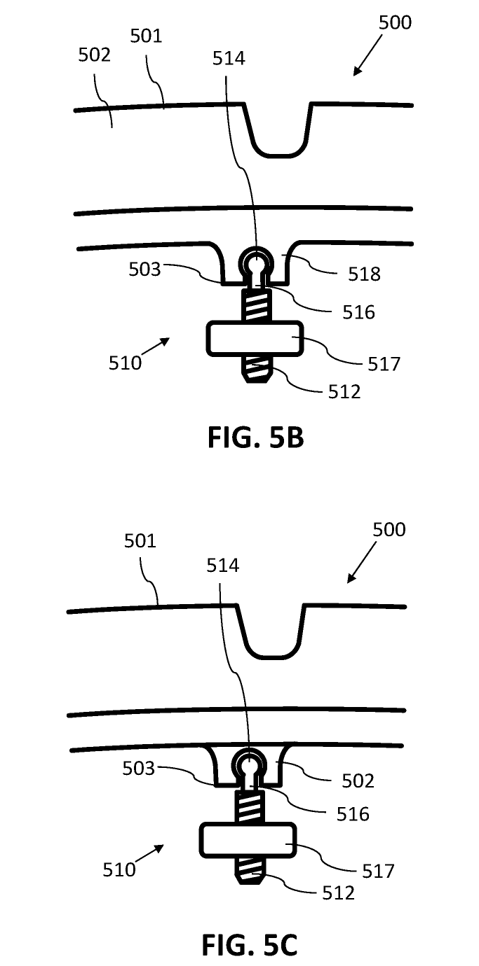

FIG. 5A illustrates a sectional view of a rubber article in the form of a tire 500 having a body 502. Tire 500 may include a tread surface 501. Tire 500 may have an inner surface 503. Inner surface 503 may include a channel, similar to channel 106 described above with reference to FIG. 1, which channel communicates with a cavity similar to cavity 104.

A fastener 510 may be coupled to tire 500. Fastener 510 may include a fastener portion 512. Fastener 510 may include a protrusion 514 for engaging a cavity of tire 500. Protrusion 514 may be oriented adjacent fastener portion 512. Protrusion 514 may attach to fastener portion 512 via a stem. A device 517 may be operatively connected to fastener portion 512.

Tire 500 may include a stanchion 518 extending radially inwardly from the remainder of body 502. Stanchion 518 may include a portion of tire 500 sized and shaped to contain a cavity, similar to cavity 104 illustrated in FIG. 1. Stanchion 518 may include a portion of tire 500 sized and shaped to contain a cavity and a channel, similar to cavity 104 and channel 106.

Body 502 may be contained between tread surface 501 of the tire and inner surface 503. Inner surface 503 may be an innerliner. Body 502 may be contained between tread surface 501 of the tire and the innerliner.

Stanchion 518 may be substantially the same material otherwise used in tire 500. Stanchion 518 may be a rubber material. Stanchion 518 may be molded into tire 500. Stanchion 518 may be manufactured as a part of tire 500. Stanchion 518 may be part of a patch added to a tire 500 following curing of tire 500. At least one of the cavity and the channel may be molded into stanchion 518 during its manufacture. Alternatively, at least one of the cavity and the channel may be machined, cut, or otherwise added to stanchion 518 after its manufacture.

Stanchion 518 may be radially inward of any reinforcement within tire 500. Stanchion 518 may be radially inward of a tire innerliner. Stanchion 518 may be covered by a tire innerliner. Stanchion 518 may be made of a material that has a permeability similar to a tire innerliner. Stanchion 518 may be made of a butyl rubber.

FIG. 5B illustrates a partial sectional view of tire 500 and fastener 510. As illustrated, protrusion 514 may be attached to fastener 510 via a stem 516. As illustrated, stanchion 518 may be an integral part of tire 500.

FIG. 5C illustrates a partial sectional view of tire 500 and fastener 510. As illustrated, protrusion 514 may be attached to fastener 510 via a stem 516.

As illustrated, stanchion 518 may be attached to tire 500. Stanchion 518 may be a part of a patch. Stanchion 518 may be attached to tire 500 following manufacture of tire 500. Stanchion 518 may be adhered to tire 500. Stanchion 518 may be fastened to tire 500. Stanchion 518 may be laminated with tire 500.

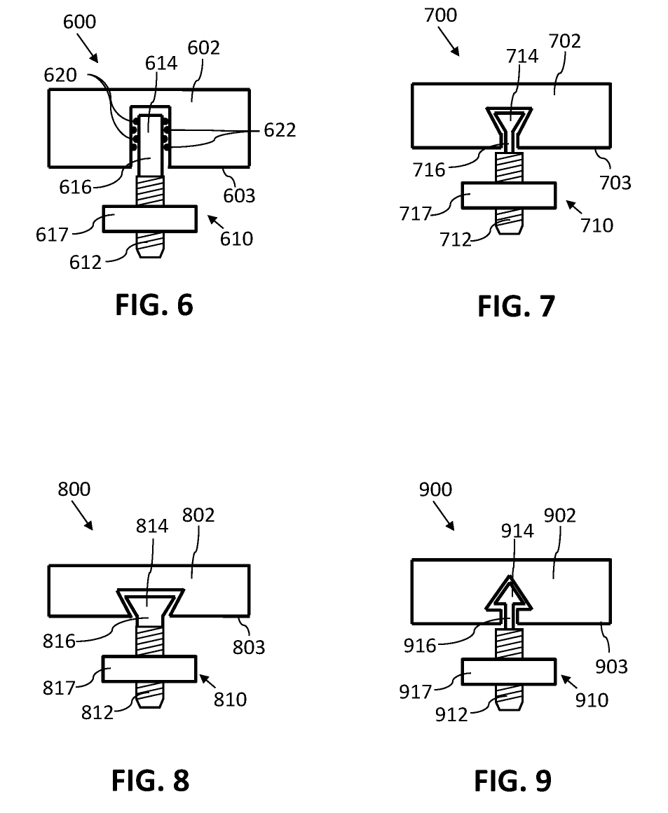

FIG. 6 illustrates a sectional view of a rubber article 600 having a body 602. Rubber article 600 may have a surface 603. Surface 603 may include a channel, similar to channel 106 described above with reference to FIG. 1, which channel communicates with a cavity similar to cavity 104.

A fastener 610 may be coupled to rubber article 600. Fastener 610 may include a fastener portion 612. Fastener 610 may include a protrusion 614 for engaging a cavity of rubber article 600. Protrusion 614 may be oriented adjacent fastener portion 612. Protrusion 614 may attach to fastener portion 612 via a stem 616. At least one of protrusion 614 and its corresponding cavity may have any of a variety of cross-sections, including for example a circular cross-section. Fastener portion 612 may engage a device 617.

As illustrated, protrusion 614 may include at least one protrusion engagement element 620 oriented on its periphery. At least one protrusion engagement element 620 may be a rib. At least one protrusion engagement element 620 may be a bump. At least one protrusion engagement element 620 may include any positive element extending from the surface of protrusion 614. Alternatively, protrusion 614 may include at least one negative element configured to engage at least one cavity engagement element 622.

The cavity may include at least one cavity engagement element 622 oriented on its inner surface. At least one cavity engagement element 622 may be a rib. At least one cavity engagement element 622 may be a bump. At least one cavity engagement element 622 may include any positive element extending from the inner surface of the cavity. Alternatively, the cavity may include at least one negative element configured to engage at least one protrusion engagement element 620.

At least one protrusion engagement element 620 may be configured to engage the cavity. At least one protrusion engagement element 620 may be configured to engage at least one cavity engagement element 622. At least one cavity engagement element 622 may be configured to engage protrusion 614. It is contemplated that protrusion 614 may include at least one protrusion engagement element 620, while the cavity does not include any cavity engagement element 622. It is contemplated that the cavity may include at least one cavity engagement element 622, while protrusion 614 does not include any protrusion engagement element 620. It is contemplated that the cavity may include at least one cavity engagement element 622 and protrusion 614 may include at least one protrusion engagement element 620.

FIG. 7 illustrates a sectional view of a rubber article 700 having a body 702. Rubber article 700 may have a surface 703. Surface 703 may include a channel, similar to channel 106 described above with reference to FIG. 1, which channel communicates with a cavity similar to cavity 104.

A fastener 710 may be coupled to rubber article 700. Fastener 710 may include a fastener portion 712. Fastener 710 may include a protrusion 714 for engaging a cavity of rubber article 700. Protrusion 714 may be oriented adjacent fastener portion 712. Protrusion 714 may attach to fastener portion 712 via a stem 716. Fastener portion 712 may engage a device 717.

As illustrated, at least one of protrusion 714 and the corresponding cavity may be in the shape of an inverted cone, an inverted tetrahedron, an inverted pyramid, and the like. At least one of protrusion 714 and the corresponding cavity may have a circular cross-section. At least one of protrusion 714 and the corresponding cavity may have a triangular cross-section. At least one of protrusion 714 and the corresponding cavity may have a quadrilateral cross-section, including for example a square cross-section or a rectangular cross-section. At least one of protrusion 714 and the corresponding cavity may have a cross-section having any number of sides.

FIG. 8 illustrates a sectional view of a rubber article 800 having a body 802. Rubber article 800 may have a surface 803. Surface 803 may include a channel, similar to channel 106 described above with reference to FIG. 1, which channel communicates with a cavity similar to cavity 104.

A fastener 810 may be coupled to rubber article 800. Fastener 810 may include a fastener portion 812. Fastener 810 may include a protrusion 814 for engaging a cavity of rubber article 800. Protrusion 814 may be oriented adjacent fastener portion 812. Protrusion 814 may attach to fastener portion 812 via a stem 816. Fastener portion 812 may engage a device 817.

As illustrated, at least one of protrusion 814 and the corresponding cavity may be in the shape of an inverted cone, an inverted tetrahedron, an inverted pyramid, and the like. At least one of protrusion 814 and the corresponding cavity may have a circular cross-section. At least one of protrusion 814 and the corresponding cavity may have a triangular cross-section. At least one of protrusion 814 and the corresponding cavity may have a quadrilateral cross-section, including for example a square cross-section or a rectangular cross-section. At least one of protrusion 814 and the corresponding cavity may have a cross-section having any number of sides.

FIG. 9 illustrates a sectional view of a rubber article 900 having a body 902. Rubber article 900 may have a surface 903. Surface 903 may include a channel, similar to channel 106 described above with reference to FIG. 1, which channel communicates with a cavity similar to cavity 104.

A fastener 910 may be coupled to rubber article 900. Fastener 910 may include a fastener portion 912. Fastener 910 may include a protrusion 914 for engaging a cavity of rubber article 900. Protrusion 914 may be oriented adjacent fastener portion 912. Protrusion 914 may attach to fastener portion 912 via a stem 916.

As illustrated, at least one of protrusion 914 and the corresponding cavity may be in the shape of a cone, a tetrahedron, a pyramid, and the like. At least one of protrusion 914 and the corresponding cavity may have a circular cross-section. At least one of protrusion 914 and the corresponding cavity may have a triangular cross-section. At least one of protrusion 914 and the corresponding cavity may have a quadrilateral cross-section, including for example a square cross-section or a rectangular cross-section. At least one of protrusion 914 and the corresponding cavity may have a cross-section having any number of sides.

It is contemplated that the force necessary to install a fastener by insertion of a protrusion through a channel and into a cavity would be any of a variety of forces. For example, a human may install the fastener as described using only the force in ones hands. A human may install the fastener using only the force in ones hands, but with the assistance of a tool. A machine may install the fastener using any amount of force necessary and possible with known machine actuation. In one embodiment, the fastener may require less force to install than to remove. In another embodiment, the fastener may require more force to install than to remove. The fastener may require about the same force to install as to remove.

Prior art devices may be adhered directly to a tire's interior surface using an adhesive, thus creating a lamination between the device, a device patch, a device base, or the like, and the tire's interior surface. During use of the tire, the tire's interior surface undergoes many deformations in each revolution of the tire (cycle of the tire). A tire may undergo a very large number of cycles in its lifetime—perhaps several million cycles. As a result, the lamination between the device, in whatever manner, and the tire's interior surface may undergo a very high number of cycles that may place any of strain on the lamination, deformation of the lamination, force within the lamination attempting to pull the device and the tire away from one another, and the like.

Attachment of a device and/or fastener to the tire in the manner described above, wherein a cavity is oriented within, or on an inner surface of, the tire, which is engaged by a protrusion extending from the fastener, eliminates many of the forces, strains, deformations, and the like found in the lamination between prior art devices and the tire interior surface when those devices are used.

Attachment of a device and/or fastener to the tire in the manner described above, wherein a cavity is oriented within, or on an inner surface of, the tire, which is engaged by a protrusion extending from the fastener, may allow the device and/or fastener to move at least somewhat relative to the tire. In this manner, the interface between the device/fastener and the tire may experience less forces, strains, and deformations than may be experienced via a more rigid interface, such as a lamination of the device directly to the tire interior. That is, the device and/or fastener, may have some “play” to move at least somewhat laterally, proximally, distally, or in terms of a tire, axially, circumferentially, or radially. This “play” may allow the device and/or fastener to be at least partially isolated from some of the forces, deformations, strains, and the like imparted to the tire from outside the tire during its operation, including for example the force imparted to the tire from hitting a pothole, or the like. While the tire deforms due to the force of hitting the pothole, the device and/or fastener may be allowed to move at least somewhat such that damage to the device is at least partially mitigated. Similarly, while the tire deforms due to the force of hitting the pothole, the interface between the fastener's protrusion and the tire's cavity is allowed some flex without detaching, whereas a traditional directly laminated device interface may not be able to withstand the strain, and may begin to partially delaminate or completely delaminate. The device and/or fastener may have some “play” particularly where the fastener protrusion is round or spherical in nature, as well as the corresponding cavity. For example, the protrusion and the cavity may interact similar to a ball and socket joint.

In each of the embodiments above, it is contemplated that a rubber article could have a protrusion, which engages a cavity within a fastener. That is, a rubber article may have a protrusion connected to the rubber article by a stem. The fastener may have a cavity in communication with a surface of the fastener via a channel. The two may engage as discussed above. The fastener may attach to a device, which could be any of the devices described herein. The rubber article could be any of the rubber articles described herein, including for example a tire.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire, comprising:
a first surface;
a second surface; and
a tire body contained between the first surface and the second surface;
wherein the tire body comprises a cavity having a cavity major width in at least one of an axial direction and a circumferential direction,
wherein a channel extends between the cavity and the first surface,
wherein the channel has a channel major width in at least one of the axial direction and the circumferential direction,
wherein the cavity major width is greater than the channel major width, and
wherein a protrusion of a fastener is engaged within the cavity.

2. The tire of claim 1, wherein the cavity has a substantially circular cross-section.

3. The tire of claim 1, wherein the channel has a substantially circular cross-section.

4. The tire of claim 1, wherein the cavity is at least one of: generally sphere-shaped, generally cylinder-shaped, generally teardrop-shaped, and generally cone-shaped.

5. The tire of claim 1, wherein the fastener includes a fastener portion, and wherein the fastener portion engages a device.

6. The tire of claim 1, wherein the fastener includes a fastener portion, and wherein the fastener portion is a threaded fastener.

7. The tire of claim 1, wherein at least one of the protrusion and the cavity comprise at least one rib.

8. A rubber article, comprising:
a surface; and
a body;
wherein the body comprises a cavity having a cavity major width,
wherein a channel extends between the cavity and the surface,
wherein the channel has a channel major width,
wherein the cavity major width is greater than the channel major width, and
wherein a protrusion of a fastener is engaged within the cavity.

9. The rubber article of claim 8, wherein the rubber article is a tire.

10. The rubber article of claim 8, wherein the cavity has a substantially circular cross-section.

11. The rubber article of claim 8, wherein the channel has a substantially circular cross-section.

12. The rubber article of claim 8, wherein the cavity is at least one of: generally sphere-shaped, generally cylinder-shaped, generally teardrop-shaped, and generally cone-shaped.

13. The rubber article of claim 8, wherein the fastener includes a fastener portion, and wherein the fastener portion engages a device.

14. The rubber article of claim 8, wherein fastener includes a fastener portion, and wherein the fastener portion is a threaded fastener.

15. The rubber article of claim 8, wherein at least one of the protrusion and the cavity comprise at least one rib.

16. A tire having a device, comprising:
a first surface;
a second surface;
a fastener having a protrusion, wherein the fastener is engaged with a device; and
a tire body contained between the first surface and the second surface;
wherein the tire body comprises a cavity having a cavity shape and a cavity major width in at least one of an axial direction and a circumferential direction,
wherein a channel extends between the cavity and the first surface,
wherein the channel has a channel major width in at least one of the axial direction and the circumferential direction,
wherein the cavity major width is greater than the channel major width,
wherein the protrusion has a protrusion shape that is complimentary to the cavity shape, and
wherein the protrusion is engaged within the cavity.

17. The tire of claim 16, wherein the protrusion has a protrusion major width, and wherein the protrusion major width is greater than the channel major width.

18. The tire of claim 16, wherein the cavity has a substantially circular cross-section.

19. The tire of claim 16, wherein the cavity and the protrusion are at least one of: generally sphere-shaped, generally cylinder-shaped, generally teardrop-shaped, and generally cone-shaped.

20. The tire of claim 16, wherein fastener includes a fastener portion, and wherein the fastener portion is a threaded fastener.
